(19) United States
(12) Patent Application Publication
(10) Pub. No.: US 2026/0358500 A1
(43) Pub. Date: Nov. 12, 2026

(54) METHOD AND SYSTEM FOR OPTICAL TRANSMISSION AND CROSSTALK REDUCTION IN LIDAR USING POLARIZED LIGHT

(71) Applicant: Arizona Board of Regents on Behalf of the University of Arizona, Tucson, AZ (US)

(72) Inventor: Stanley Pau, Tucson, AZ (US)

(21) Appl. No.: 19/137,254

(22) PCT Filed: Dec. 19, 2023
(86) PCT No.: PCT/US2023/084936

§ 371 Date: Jun. 9, 2025

Related U.S. Application Data
(60) Provisional application No. 63/476,890, filed on Dec. 22, 2022.

(51) Int. Cl. G01S 17/88; G01S 7/481; G01S 7/484; G01S 7/487; G01S 7/499

(52) U.S. Cl. CPC G01S 17/88; G01S 7/4816; G01S 7/484; G01S 7/487; G01S 7/499; G01S 7/4815

(57) ABSTRACT

Methods, devices and systems for improved pulsed optical communications, including for light detection and ranging (LiDAR) systems, are described. One example method for generating pulsed communication signals includes selecting a key code for encoding into a pulsed optical signal, where the key code identifies a transmitter of the pulsed optical signal. Optical pulses are then generated such that each optical pulse is separated in time from an adjacent pulse and has a corresponding amplitude. The key code is encoded into the optical pulses based on at least two of the following: relative separations between adjacent pulses, amplitude of each pulse, or a polarization state of the pulses. The optical pulses are then transmitted in the direction of an object, and the presence of the key code in a return sequence enables a determination that the return sequence was received in response to transmission of the optical pulses by the transmitter.

### CROSS-REFERENCE TO RELATED APPLICATION(S)

This application claims priority to the provisional application with Ser. No. 63/476,890, titled “METHOD AND SYSTEM FOR OPTICAL TRANSMISSION AND CROSSTALK REDUCTION IN LIDAR USING POLARIZED LIGHT,” filed Dec. 22, 2022. The entire contents of the above noted provisional application are incorporated by reference as part of the disclosure of this document.

### TECHNICAL FIELD

The technology described in this patent document generally relates to pulsed communication systems and methods, and more particularly to techniques for light ranging and detection.

### BACKGROUND

Conventional light detection and ranging (LiDAR) systems are made of multiple components including a modulated pulsed laser source, a scanner, light collection optics, and a receiver with data processing electronics and power supplies. Some implementations include a position and navigation system such as an accelerometer, a gyroscope and a global positioning system (GPS). LIDAR can be classified as coherent or incoherent depending on the detection scheme. The detector can be a single detector or a 1-dimensional (1D) or a 2-dimensional (2D) array of detectors with many pixels. In coherent LiDAR, heterodyne detection is used to detect phase shifts between the reference and the reflected pulses. In incoherent LiDAR, the intensity of the pulse is measured by a fast and sensitive detector, and a distance is calculated based on the pulse delay.

As deployment of LiDAR becomes more and more widespread with increasing demand in the many applications including auto industry, there is a need to identify unique transmitter and receiver pairs in order to reduce crosstalk and generation of spurious point clouds.

### SUMMARY

The disclosed embodiments relate to methods and devices that, among other features and benefits, uniquely identify a light detection and ranging (LiDAR) system.

One aspect of the disclosed embodiments relates to a method for generating pulsed communication signals that can be used in a LiDAR system. The method includes selecting a key code for encoding into a pulsed optical signal, wherein the key code identifies a transmitter of the pulsed optical signal, and generating a plurality of optical pulses such that each optical pulse is separated from an adjacent optical pulse in time domain and each optical pulse has a corresponding amplitude, wherein the key code is encoded into the plurality of optical pulses based on at least two of the following: (a) relative separations between adjacent pulses of the plurality of optical pulses, (b) amplitude of each pulse in the plurality of optical pulses, or (c) a polarization state of one or more optical pulses of the plurality of optical pulses. The method further includes transmitting the plurality of optical pulses in a direction of an object, wherein a presence of the key code in a return sequence of optical pulses enables a determination that the return sequence of optical signals was received in response to transmission of the plurality of optical pulses by the transmitter.

### BRIEF DESCRIPTION OF THE DRAWINGS

FIG. 1A illustrates an example output of a transmitter where each pulse is separated by a particular time period.

FIG. 1B illustrates another example output of a transmitter with three pulses within a particular time period.

FIG. 2A illustrates an example encoding of a 4-bit key as four light pulses with different time separations.

FIG. 2B illustrates an example encoding of a 4-bit key using two light pulses with different time separations.

FIG. 3A illustrates an encoding technique using four light pulses as a 4-bit key with different time separations and orthogonal circular polarization states in accordance with an example embodiment.

FIG. 3B illustrates another encoding technique using four light pulses as a 4-bit key with different time separations and orthogonal elliptical polarization states in accordance with another example embodiment.

FIG. 4 illustrates a receiver system that can be used to measure the reflected pulses shown in FIGS. 3A and 3B in accordance with an example embodiment.

FIG. 5 illustrates a transmitter system that can be used to generate light pulses shown in FIGS. 3A and 3B in accordance with an example embodiment.

FIG. 6A illustrates an example encoding technique using a unique key code as four light pulses with different time separations and four different polarization states with four Stokes parameters in accordance with an example embodiment.

FIG. 6B illustrates another example encoding technique using a unique key code as four light pulses with different time separations and four different polarization states with four Stokes parameters in accordance with another example embodiment.

FIG. 7 illustrates a transmitter system that can be used to generate light pulses shown in FIGS. 6A and 6B in accordance with an example embodiment.

FIG. 8 illustrates a receiver system that can be used to measure the Stokes parameters of the light pulse generated in accordance with an example embodiment.

FIG. 9 illustrates a set of operations that can be carried out to generate, transmit and detect LiDAR pulses in accordance with an example embodiment.

FIG. 10 illustrates another set of operations that can be carried out to generate, transmit and detect LiDAR pulses in accordance with another example embodiment.

FIG. 11 illustrates a set of example operations that can be carried out for generating pulsed communication signals in accordance with an example embodiment.

### DETAILED DESCRIPTION

The use of LiDAR systems has proliferated to many applications including remote sensing, autonomous vehicle navigation, 3D imaging and others, and it is important to identify unique transmitter and receiver pairs in order to reduce crosstalk and generation of spurious point clouds. Automotive LiDAR, for example, often has a set of unique requirements such as a range of 150 m or longer, laser safety and free space transmission that can particularly benefit from a reduction of noise, crosstalk and other sources of interference.

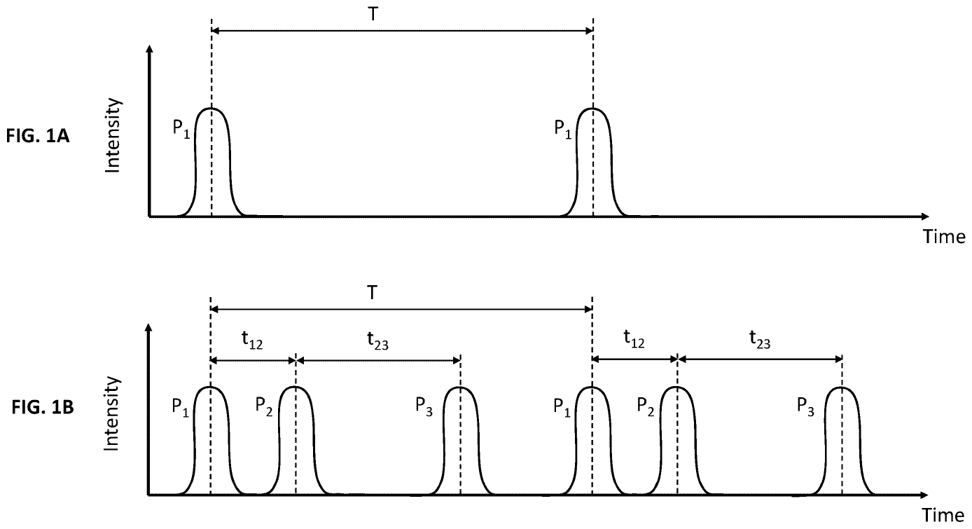

A periodic train of a single pulse of light can be identified by its spatial profile, direction, spectrum, pulse shape, phase distribution and polarization. A common configuration is shown in FIG. 1A where each pulse is separated in time by a period T. While it is possible to generate a unique signature of a single pulse by adjusting the aforementioned pulse parameters, accurate detection of all parameters in a noisy environment is a difficult problem and requires additional complexity and overhead. For example, existing pulse detection techniques such as frequency-resolved optical gating (FROG) can be used to detect both the intensity and phase of a light pulse. An alternate and simpler solution utilizes identification and encoding using more than a single pulse. In ON-OFF keying (OOK), each bit is denoted by a different intensity of light, most commonly as zero and a predefined fixed intensity. In this way, binary data or bits of information can be encoded in a train of multiple pulses of light. The binary data serves as the key. This encoding provides a unique signature for a transmitter-receiver pair operating in a noisy environment where there can be many transmitters with the same spatial profile, direction, spectrum, pulse shape, phase distribution and polarization. In addition to OOK, other common modulation schemes that can be used include frequency shift keying (FSK) and phase shift keying (PSK). OOK is sometimes used along with optical code division multiple access (OCDMA) technique.

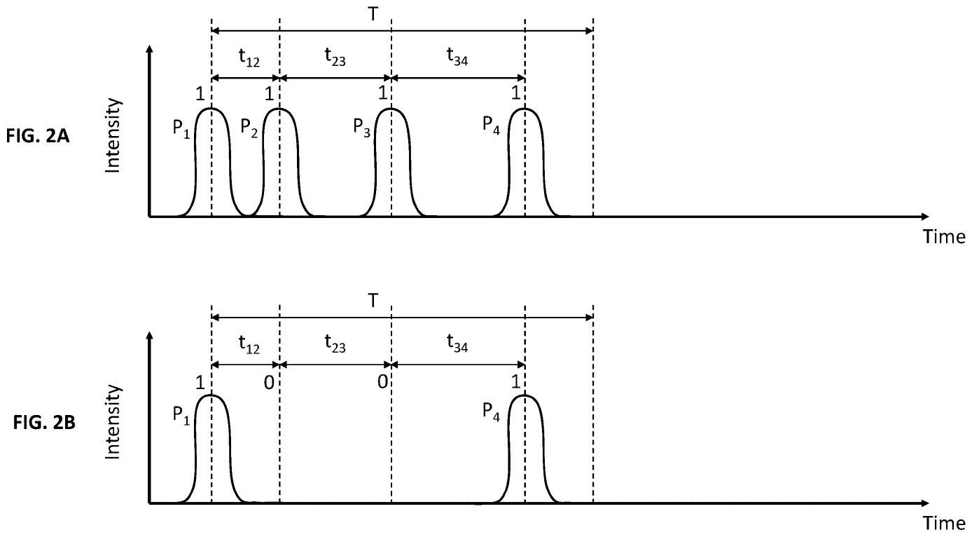

FIG. 1B shows the output of a transmitter with three pulses, P₁, P₂ and P₃ with a time period T. The relative time delay between P1 and P2 is t₁₂, and the relative time delay between P₂ and P₃ is t₂₃. For each LiDAR system, the relative time delays, t₁₂ and t₂₃, in addition to the bit sequence, can be chosen to be different or generated by a random (or pseudo-random) algorithm, so that the transmitter is uniquely identified. As an example, FIG. 2A shows the encoding of a 4-bit key 1111 as four light pulses P₁, P₂, P₃ and P₄ with different time separations. As another example, FIG. 2B shows the encoding of a 4-bit key 1001 as two light pulses P₁ and P₄ with different time separations.

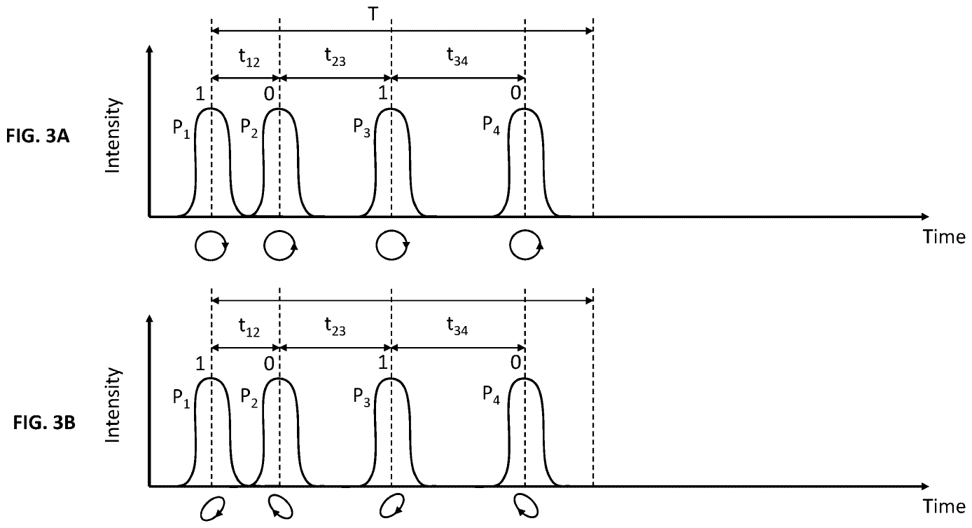

Binary encoding can be implemented by using light pulses with orthogonal polarization states. The polarization states can be linear, elliptical or circular polarization states. In this case, one orthogonal polarization state represents the bit value zero, while the other orthogonal polarization state represents the bit value one. FIG. 3A shows an example embodiment with encoding of a 4-bit key 1010 as four light pulses P₁, P₂, P₃ and P₄ with different time separations and orthogonal circular polarization states (e.g., a 0-bit has a left and a 1-bit has a right circular polarization). FIG. 3B shows another example embodiment with encoding of a 4-bit key 1010 as four light pulses P₁, P₂, P₃ and P₄ with different time separations and orthogonal elliptical polarization states. The polarization encoding can be combined with random pulse delay to provide a unique key for a LiDAR system. This combination of encodings is more robust and less susceptible to error when compared with system using only random pulse delay.

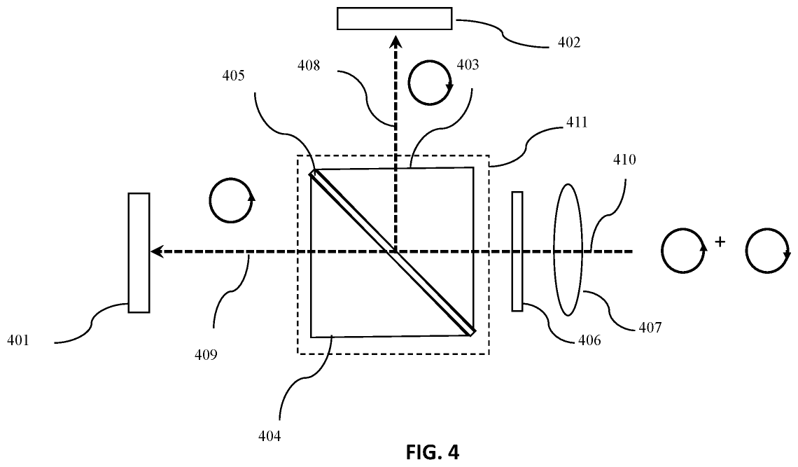

FIG. 4 shows an example receiver system 400 that can be used to measure the reflected pulses shown in FIGS. 3A and 3B. The system 400 includes two detectors 401 and 402, a polarization beam splitter (PBS) 411, optical filter 406, such as a polarizer, a retarder and/or a bandpass filter, and collection optics 407. The PBS is made of two prisms 403 and 404 with birefringent coatings 405. In an example embodiment, the PBS 411 can be designed and fabricated using liquid crystal polymer. The transmitted pulse train 410 (shown as a dashed line along the optical axis) is separated into orthogonal polarization components 408 and 409 and is subsequently identified by its unique relative time delays among the pulses, and polarization pulse encoding. For example, component 409 can have left circular polarization, and the component 408 can have right circular polarization. The system 400 can be generalized to measure different orthogonal polarization states, including linear, elliptical and circular polarization states.

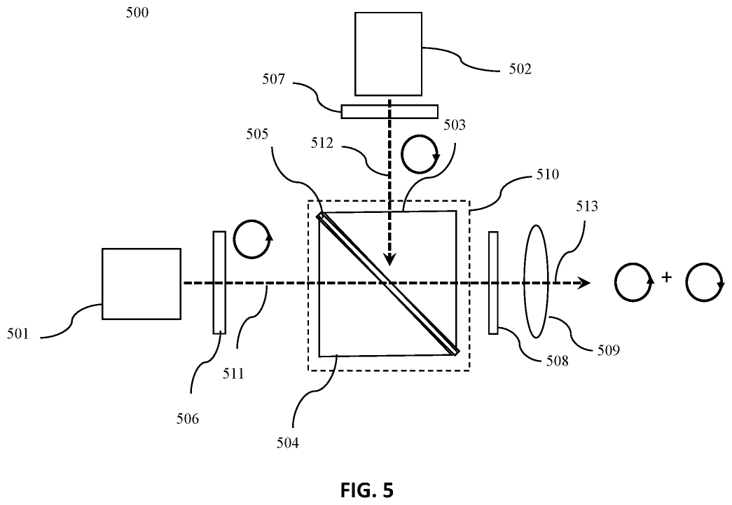

FIG. 5 shows an example transmitter system 500 that can be used to generate light pulses shown in FIGS. 3A and 3B. The system 500 includes two pulsed light sources 501 and 502, a polarization beam splitter (PBS) 510 (used a combiner in FIG. 5), optical filters 506, 507 and 508, such as a polarizer, a retarder and/or a bandpass filter, and projection optics 509. Component 508 can be used to prevent unwanted light from being back reflected or scattered to the sources 501, 502. The sources 501, 502 are coupled to (or include) a controller or processor that allows optical pulses with prescribed separations and intensity/amplitude to be generated. The light sources can include a laser, a modulator, collimation optics and/or an amplifier. The PBS is made of two prisms 503 and 504 with birefringent coatings 505. The PBS 510 can be designed and fabricated using liquid crystal polymer. The pulse train 513 is combined from orthogonal polarization components 511 and 512 and is subsequently identified by its unique relative time delays (associated with its constituent pulses) and polarization pulse encoding using receiver system 400 after reflection from a target. The system 500 can be generalized to transmit different orthogonal polarization states, including linear, elliptical and circular polarization states.

In some embodiments, instead of binary coding using two orthogonal polarization states, the key information can be encoded into the polarization state of the light pulse. In this case, the number of pulses in the pulse train can be greater than or equal to one. The polarization state is described by four components, i.e., Stokes parameters, S̅ₚ̅ᵤ̅ₗ̅ₛ̅ₑ̅=[S₀, S₁, S₂, S₃]. The Stokes parameters are often normalized by the pulse irradiance S₀ as [1, S₁/S₀, S₂/S₀, S₃/S₀]. Each of the three normalized Stokes parameters, S_{1,2,3}/S₀, can represent a binary number, for example as an 8-bit number.

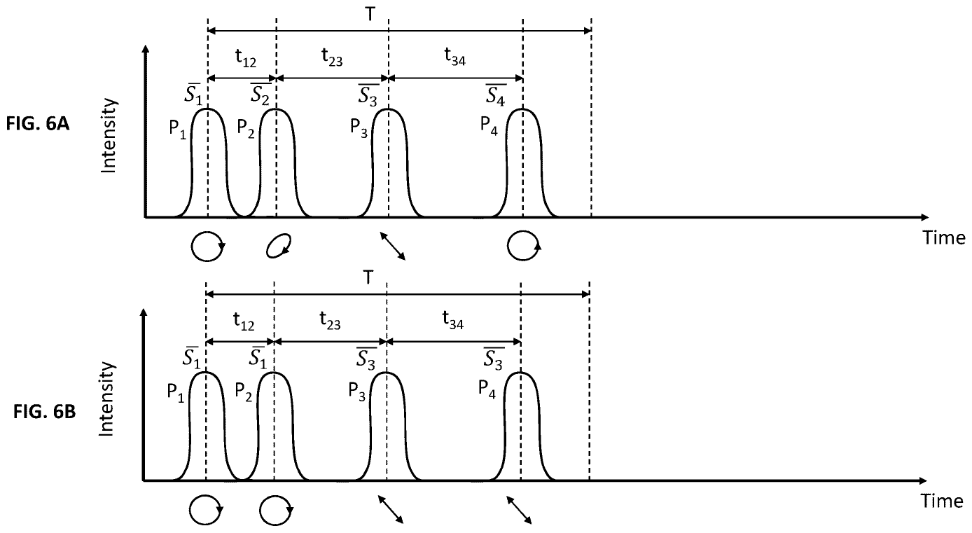

FIG. 6A shows one example embodiment with encoding of a unique key code as four light pulses P₁, P₂, P₃ and P₄ with different time separations and four different polarization states with Stokes parameters S̅₁̅, S̅₂̅, S̅₃̅ and S̅₄̅. P₁ has right circular polarization. P₂ has right elliptical polarization. P₃ has linear polarization. P₄ has left circular polarization. The exact value of the Stokes parameters can be chosen by a random algorithm. FIG. 6B shows another example embodiment with encoding of a unique key code as four light pulses P₁, P₂, P₃ and P₄ with different time separations and two pairs of two different polarization states with Stokes parameters S̅₁̅ and S̅₃̅. P₁ and P₂ have right circular polarization. P₃ and P₄ have linear polarization. In this case, the number of pulses in the pulse train during time T are even, and the key is encoded in duplicates to provide redundancy.

In conventional LiDAR systems that do not use a polarization modulation scheme, the reflected pulse signal depends on the reflectance of the object. Objects with high absorption and light scattering tend to reflect less light back to the receiver. In most situations, the reflected light has a sizable component from the specular reflection at direct normal incidence to the object. The signal to noise ratio can be increased by increasing the energy of the light pulse or by changing the wavelength of light to a wavelength that produces a higher reflectance. For automotive applications, the pulse energy is limited by the laser safety standards. In the disclosed LiDAR systems similar to those in FIG. 6, the reflected pulse signal depends not only on the reflectance of the object, but also on its diattenuation and retardance. Diattenuation converts unpolarized light into polarized light, and retardance converts one type of polarized light to another type of polarized light. Diattenuation can be classified as linear, elliptical and circular. Similarly, retardance can be classified as linear, elliptical and circular. In addition, some materials can depolarize light. Materials with diattenuation and retardance are birefringent, with anisotropic reflectance that depends on the polarization state of the incident light. Thus, when polarized light pulse is reflected from a birefringent object at direct normal incident, the light pulse can be attenuated, and the polarization state of the light pulse can be modified. In order to distinguish these changes, the transmitted light pulse can be sent in duplicate pairs as shown in FIG. 6B. When the duplicate pulses are reflected, the polarization state of the two pulses are changed identically. Therefore, the detection of identically changed polarization of pulses in the predetermined sequence can used by the receiver to identify the corresponding transmitter even if the correct polarization state is not received. Triplicate pulses or higher number of pulses can also be used.

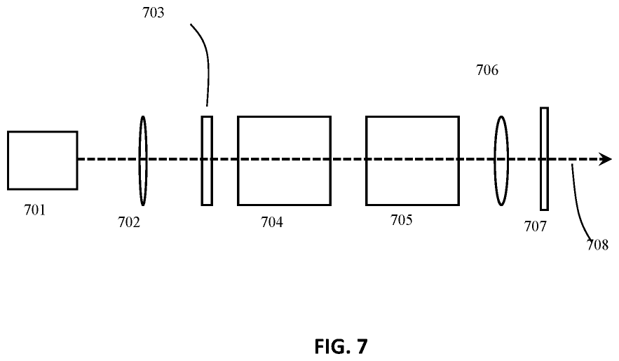

FIG. 7 shows an example transmitter system 700 that can be used to generate light pulses shown in FIGS. 6A and 6B. The electronic driver of the transmitter is not shown. The transmitter includes a pulsed light source 701, collimating lens 702, polarizer 703, first tunable retarder 704, second tunable retarder 705, collimating lens 706 and optical filter 707. The tunable retarder 704 can be implemented using electro-optic modulators such as Pockels cells or lithium niobate phase modulators. The filter 707 can be a bandpass filter. An example method for generating an arbitrary polarization state using the tunable retarder is described in U.S. Pat. No. 11,067,837. The polarization state of the output light 708 can be controlled to be any polarization state on the Poincaré sphere by modifying the optical axis and/or retardance of 704 and 705. This is usually done by changing the applied voltages on the tunable retarder.

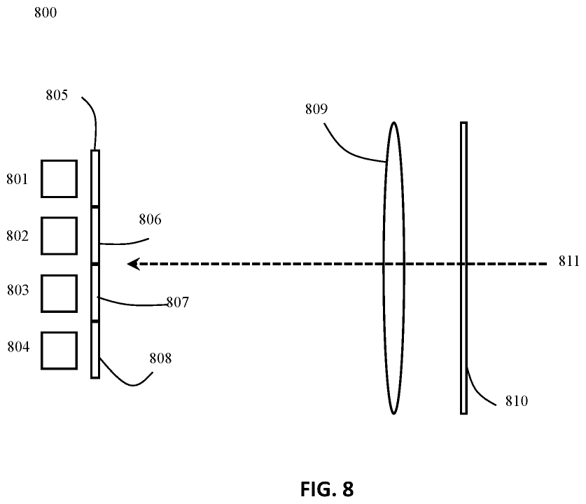

FIG. 8 shows an example receiver system 800 that can be used to measure the Stokes parameters of the light pulse (e.g., the pulse shown in FIGS. 6A and 6B). The receiver system includes four detectors, 801, 802, 803 and 804, four different polarizers, 805, 806, 807 and 808, collection optics 809 and optical filter 810. The incoming light pulse 811 is incident on all four detectors. The four polarizers can be a linear polarizer having a polarization axis at zero-degrees, a linear polarizer at 90 degrees, a linear polarizer at 45 degrees and a right circular polarizer. Alternatively, the four polarizers can be four different elliptical polarizers. Different configurations of polarizers and its manufacturing process are described in U.S. Pat. No. 10,254,453. Although the configuration shown in FIG. 8 uses four detectors and polarizers, in other embodiments a lower or a higher number of detectors may be used. A lower number of detectors allows partial measurement of the Stokes parameter, while a higher number of detectors allows more accurate measurement of the Stokes parameter. The Stokes parameters of the light pulse can be chosen from a predefined library or chosen in accordance with a random algorithm to provide a unique signature.

For some applications, the encoding techniques shown in FIGS. 3A-B and FIGS. 6A-B can be combined.

The pulse encoding can include an error-detecting code such as a parity check or a checksum algorithm which allows error detection and corrective action for any data corruption. A common checksum algorithm is the cyclic redundancy check (CRC) which is based on division. The checksum of data is calculated, and the checksum is attached to the data as padding bits for pulsed transmission. For LiDAR operation, the pulses are detected, and the delay between the transmitted and detected pulse train are calculated. In addition, the CRC value of the detected pulse data are verified by comparing with the transmitted pulse data. The number of bits encoded in a pulse train can be, for example, 8, 16, 32, 64 or higher. Each key presents a unique identification of the receiver and detector LiDAR system.

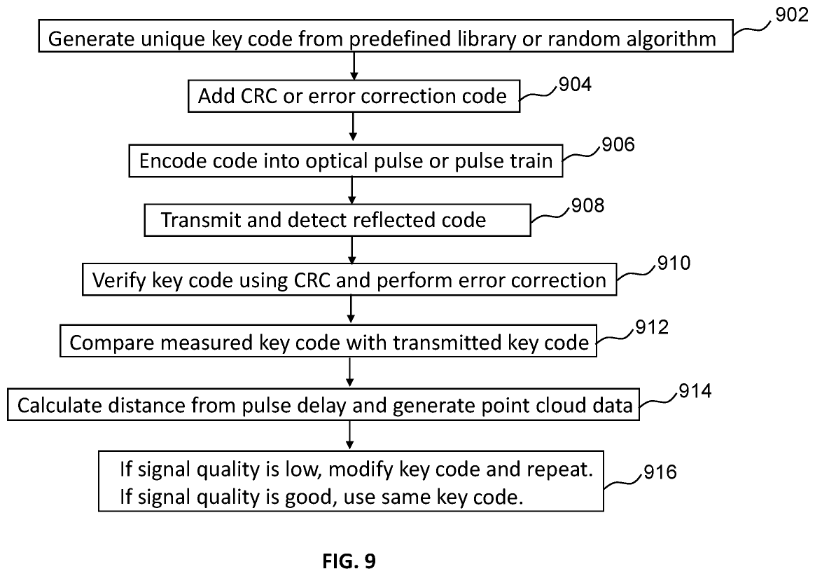

The disclosed embodiments provide multiple layers of verification. The usage of pulse delay, polarization pulse encoding and CRC defines a unique identification key for a transmitter/receiver LiDAR system with multiple layers of redundancy and verification. FIG. 9 shows a block diagram of an embodiment of the measurement process. In this measurement process, the key code is changed only when the signal quality is low. At 902, a unique key code is generated using a predefined library (e.g., a lookup table) or using a random algorithm. At 904, a CRC or an error correction code is generated based on the key code, and is combined with the key code to form a binary message. At 906, the binary message generated at 904 is encoded into the optical pulse, or pulse train. At 908, the optical pulse(s) are transmitted toward the object and the reflected pulses are detected and converted to a binary sequence of bits. At 910, CRC and/or error correction/detection is performed to verify the binary sequence. If the CRC or error correction is successful, at 912, the binary key code obtained from the reflected pulses is compared against the transmitted key code. If the two match, at 914, the distance to the object is computed using the pulse delays, and the point cloud data is generated. At 916, if the signal quality is low, the key code is modified and the operations are repeated; if the signal quality is satisfactory, the same key code is used to make further measurements. In the embodiment of FIG. 9, when the signal quality is low, the result of prior measurements may still be used to, for example, verify the subsequent measurements, or to contribute to decision making via, for example, averaging.

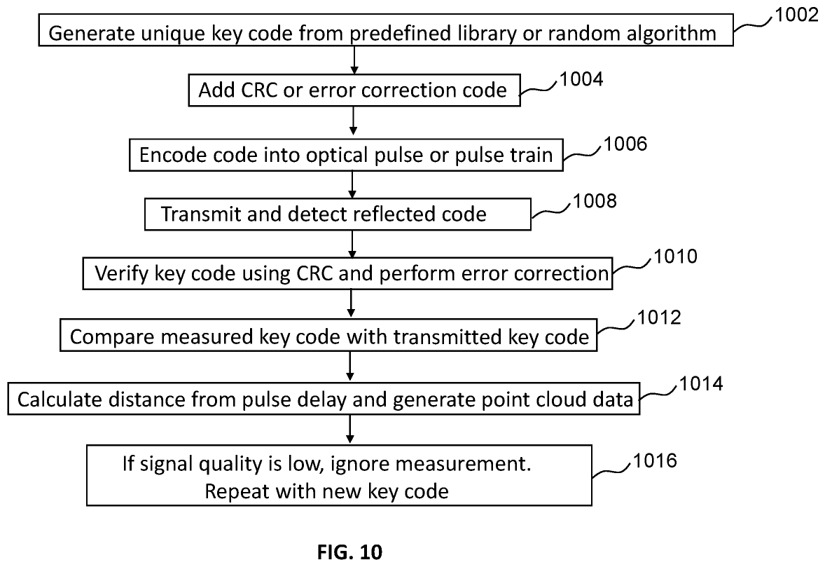

FIG. 10 shows a block diagram of another example embodiment of the measurement process. In this measurement process, the key code is constantly changing using, for example, a random algorithm. The operations 1002 to 1014 are similar to operations 902 to 914 in FIG. 9. However, in operation 1016, if the signal quality is low, the measurement is ignored, and the operations are repeated with a new code. Even if the signal quality is high, the next measurement uses a new key code.

One application of the disclosed encoding methods relates to the transmission of information in free space telecommunication. For example, the transmitters described in FIG. 4 and FIG. 7 can be located in one location, and the receivers described in FIG. 5 and FIG. 8 can be located in an alternative location. Information can be encoded in binary format using two orthogonal polarization states or in Stokes parameters.

It should be noted that while some of example embodiments described herein use four pulses to encode the key code, it is understood that fewer or additional pulses can be used to encode the key code. Increasing the number of pulses allows for encoding of larger key codes and/or provides coding redundancy that can be leveraged to improve the accuracy of detections.

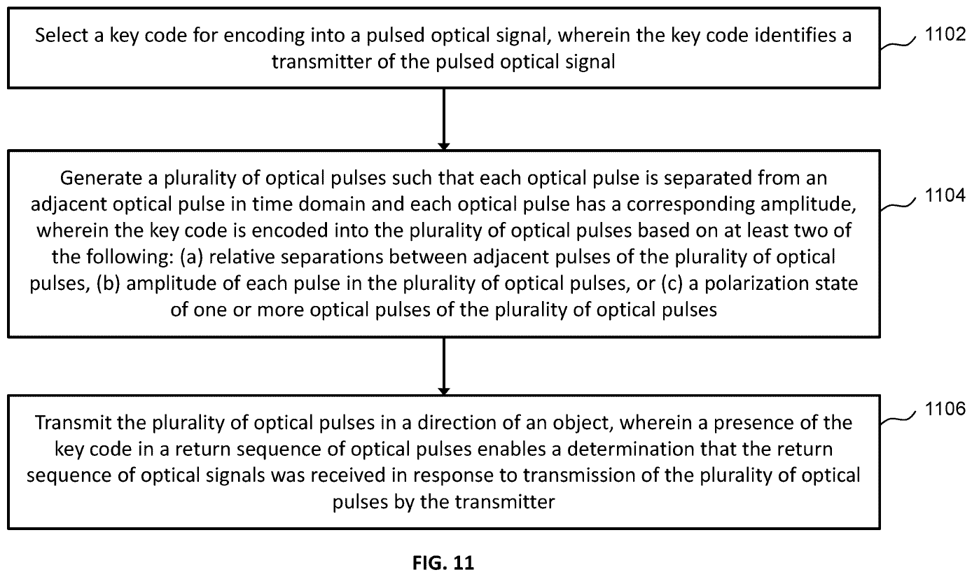

FIG. 11 illustrates a set of example operations that can be carried out for generating pulsed communication signals in accordance with an example embodiment. At 1102, a key code is selected for encoding into a pulsed optical signal, wherein the key code identifies a transmitter of the pulsed optical signal. At 1104, a plurality of optical pulses are generated such that each optical pulse is separated from an adjacent optical pulse in time domain and each optical pulse has a corresponding amplitude. The key code is encoded into the plurality of optical pulses based on at least two of the following: (a) relative separations between adjacent pulses of the plurality of optical pulses, (b) amplitude of each pulse in the plurality of optical pulses, or (c) a polarization state of one or more optical pulses of the plurality of optical pulses. At 1106, the plurality of optical pulses is transmitted in a direction of an object, wherein a presence of the key code in a return sequence of optical pulses enables a determination that the return sequence of optical signals was received in response to transmission of the plurality of optical pulses by the transmitter.

In one example embodiment, the amplitude of each optical pulse has one of two values, each value representing either a binary zero or a binary one. In another example embodiment, the two values are zero and a fixed value other than zero. In yet another example embodiment, the separations between adjacent pulses are determined based on a random or pseudo-random algorithm. In still another example embodiment, the key code is represented by a binary number, and the binary number is mapped to the plurality of optical pulses based on the relative separations between adjacent pulses and an order in which pulses with one or more particular amplitudes appear in the plurality of optical pulses.

According to another example embodiment, the polarization state of the one or more optical pulses constitutes one variable that allows mapping of at least part of the key code onto the plurality of optical pulses. In one example embodiment, the polarization state of the one or more optical pulses is one of a linear, circular or elliptical polarization. In another example embodiment, the polarization state of the one or more optical pulses is one of a right handed or a left handed polarization. In yet another example embodiment, the polarization state of the one or more optical pulses is determined according to Stokes parameters that allow selection of any polarization state on a Poincaré sphere.

In another example embodiment, the above noted set of operations includes generating one or more error detection or error correction codes based on the key code, and appending the error detection or error correction code symbols to the key code to form a key code message; in this example embodiment, generating the plurality of optical pulses includes generating the plurality of optical pulses that encodes the key code message. In still another example embodiment, generating the plurality of optical pulses comprises generating two or more optical pulses that redundantly encode the same bit of the key code.

In another example embodiment, that above noted set of operations further includes receiving the return sequence of optical pulses, determining a candidate key code value from the return sequence of optical pulses based on at least two of the following: (a) relative separations between adjacent pulses of the return sequence of optical pulses, (b) amplitude of one or more pulses in the return sequence of optical pulses, or (c) a polarization state of one or more pulses in the return sequence of optical pulses, and verifying whether the candidate key code represents the key code that identifies the transmitter. In one example embodiment, verifying whether the candidate key code represents the key code includes determining whether the candidate key code matches the key code.

In yet another example embodiment, generating a plurality of optical pulses includes generating one or more error detection or error correction code symbols based on the key code, appending the error detection or error correction code symbols to the key code to form a key code message, and generating the plurality of optical pulses that encodes the key code message. In this example embodiment verifying whether the candidate key code represents the key code includes: determining whether the candidate key code includes one or more errors based on performing an error detection or error correction decoding operation, and upon a successful error detection or error correction operation, determining whether the candidate key code matches the key code. In one example embodiment, performing the error correction decoding operation includes correcting one or more errors in the candidate key code.

In another example embodiment, the above noted operations include, upon a determination that the candidate key code does not match the key code, or that a quality of the return sequence of optical pulses does not conform to a predetermined criterion, selecting a new key code, and repeating the generate operation (1104) and the transmit operation (1104) using the new key code; and upon a determination that the candidate key code matches the key code, using the key code for a subsequent generation of the plurality of optical pulses and transmission thereof. In one example embodiment, the above noted operations further include selecting a new key code, and performing the generation (1104) and the transmission (1106) operations using the new key code.

Another aspect of the disclosed embodiments relates to a system for pulsed optical communications that includes a processor, and a memory including instructions stored thereon. The instructions upon execution by the processor cause the processor to select or determine a key code and at least two of the following: (a) separation values between adjacent optical pulses of a pulsed optical signal for representing the key code, (b) an amplitude value for each of the optical pulses for representing the key code or (c) a polarization state of one or more optical pulses for representing the key code. The system further includes one or more optical sources coupled to the processor and configured to generate one or more sequences of optical pulses having adjacent pulses that are separated according to the separation values or amplitude values, or both, that are selected or determined by the processor. The system further includes one or more polarization control components coupled to the processor; each polarization control component is configured to receive optical pulses from the one or more optical sources and impart a particular polarization state to one or more of the optical pulses as selected or determined by the processor. The system additionally includes projection optics to transmit the optical pulses after modification of their amplitudes or polarization states.

In one example embodiment, the instructions upon execution by the processor cause the processor to select or determine the separation values based on a random algorithm. In another example embodiment, the system further includes a receiver that includes collection optics configured to receive a return optical pulse sequence, and one or more optical filters positioned to receive the return optical pulse sequence from the collection optics, where the one or more optical filters are selected from a polarizer, a retarder or a bandpass filter. The receiver further includes a polarization beam splitter configured to receive light that is output from the one or more filters, and one or more detectors configured to receive light after traversing through the polarization beam splitter.

It should be noted that the described system can include components or perform operations that were previously recited in connection with FIG. 11 and embodiments thereof.

It is understood that the various disclosed embodiments may be implemented individually, or collectively, using devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. For example, the processor may be configured to determine the key code, the CRC or error correction code, to control various optical and electrical components to produce the pulses that convey the key code information; similarly on the reception side, the same or a different processor may be used to receive and decode the information, and to perform other operations based on the techniques disclosed herein.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

1. A method for generating pulsed communication signals, comprising:
selecting a key code for encoding into a pulsed optical signal, wherein the key code identifies a transmitter of the pulsed optical signal;
generating a plurality of optical pulses such that each optical pulse is separated from an adjacent optical pulse in time domain and each optical pulse has a corresponding amplitude, wherein the key code is encoded into the plurality of optical pulses based on at least two of the following: (a) relative separations between adjacent pulses of the plurality of optical pulses, (b) amplitude of each pulse in the plurality of optical pulses, or (c) a polarization state of one or more optical pulses of the plurality of optical pulses; and
transmitting the plurality of optical pulses in a direction of an object, wherein a presence of the key code in a return sequence of optical pulses enables a determination that the return sequence of optical pulses was received in response to transmission of the plurality of optical pulses by the transmitter.

2. The method of claim 1, wherein the amplitude of each optical pulse has one of two values, each value representing either a binary zero or a binary one.

3. The method of claim 2, wherein the two values are zero and a fixed value other than zero.

4. The method of claim 1, wherein the relative separations between adjacent pulses are determined based on a random or pseudo-random algorithm.

5. The method of claim 1, wherein the key code is represented by a binary number, and the binary number is mapped to the plurality of optical pulses based on the relative separations between adjacent pulses and an order in which pulses with one or more particular amplitudes appear in the plurality of optical pulses.

6. The method of claim 1, wherein the polarization state of the one or more optical pulses constitutes one variable that allows mapping of at least part of the key code onto the plurality of optical pulses.

7. The method of claim 6, wherein the polarization state of the one or more optical pulses is one of a linear, circular or elliptical polarization.

8. The method of claim 6, wherein the polarization state of the one or more optical pulses is one of a right handed or a left handed polarization.

9. The method of claim 6, wherein the polarization state of the one or more optical pulses is determined according to Stokes parameters that allow selection of any polarization state on a Poincaré sphere.

10. The method of claim 1, further comprising generating one or more error detection or error correction codes based on the key code, and appending the one or more error detection or error correction code symbols to the key code to form a key code message, wherein generating the plurality of optical pulses includes generating the plurality of optical pulses that encodes the key code message.

11. The method of claim 1, wherein generating the plurality of optical pulses comprises generating two or more optical pulses that redundantly encode the same bit of the key code.

12. The method of claim 1, further comprising:
receiving the return sequence of optical pulses;
determining a candidate key code from the return sequence of optical pulses based on at least two of the following: (a) relative separations between adjacent pulses of the return sequence of optical pulses, (b) amplitude of one or more pulses in the return sequence of optical pulses, or (c) a polarization state of one or more pulses in the return sequence of optical pulses; and
verifying whether the candidate key code represents the key code that identifies the transmitter.

13. The method of claim 12, wherein verifying whether the candidate key code represents the key code includes determining whether the candidate key code matches the key code.

14. The method of claim 12, wherein:
generating the plurality of optical pulses includes generating one or more error detection or error correction code symbols based on the key code, appending the one or more error detection or error correction code symbols to the key code to form a key code message, and generating the plurality of optical pulses that encodes the key code message; and
verifying whether the candidate key code represents the key code includes:
determining whether the candidate key code includes one or more errors based on performing an error detection or error correction decoding operation, and
upon a successful error detection or error correction operation, determining whether the candidate key code matches the key code.

15. The method of claim 14, wherein performing the error correction decoding operation includes correcting one or more errors in the candidate key code.

16. The method of claim 12, comprising:
upon a determination that the candidate key code does not match the key code, or that a quality of the return sequence of optical pulses does not conform to a predetermined criterion, selecting a new key code, and repeating the generating and the transmitting operations of claim 1 using the new key code; and
upon a determination that the candidate key code matches the key code, using the key code for a subsequent generation of the plurality of optical pulses and transmission thereof.

17. The method of claim 12, further comprising selecting a new key code, and performing the generating and the transmitting operations of claim 1 using the new key code.

18. A system for pulsed optical communications, comprising:
a processor;
a memory including instructions stored thereon, wherein the instructions upon execution by the processor cause the processor to select or determine a key code and at least two of the following: (a) separation values between adjacent optical pulses of a pulsed optical signal for representing the key code, (b) amplitude values for optical pulses for representing the key code or (c) a polarization state of one or more optical pulses for representing the key code;
one or more optical sources coupled to the processor and configured to generate one or more sequences of optical pulses having adjacent pulses that are separated according to the separation values or optical pulses having the amplitude values, or both, that are selected or determined by the processor;
one or more polarization control components coupled to the processor, each polarization control component configured to receive the one or more sequences of optical pulses from the one or more optical sources and impart a particular polarization state to one or more of the optical pulses of the one or more sequences of optical pulses; and
projection optics to transmit the one or more sequence of optical pulses after modification of their amplitudes or polarization states.

19. The system of claim 18, wherein the instructions upon execution by the processor cause the processor to select or determine the separation values based on a random algorithm.

20. The system of claim 18, further comprising a receiver that includes:
collection optics configured to receive a return optical pulse sequence;
one or more optical filters positioned to receive the return optical pulse sequence from the collection optics, the one or more optical filters include a polarizer, a retarder or a bandpass filter;
a polarization beam splitter configured to receive light that is output from the one or more optical filters; and
one or more detectors configured to receive light after traversing through the polarization beam splitter.
